(19) United States
(12) Patent Application Publication
(10) Pub. No.: US 2024/0017364 A1
(43) Pub. Date: Jan. 18, 2024

(54) SPINDLE DEVICE

(71) Applicant: NTN Corporation, Osaka (JP)

(72) Inventor: Teruyoshi HORIUCHI, Iwata-shi, Shizuoka (JP)

(21) Appl. No.: 18/039,694

(22) PCT Filed: Nov. 18, 2021
(86) PCT No.: PCT/JP2021/042395

§ 371 Date: May 31, 2023

(30) Foreign Application Priority Data
Dec. 3, 2020 (JP) 2020-201032

(51) Int. Cl. B23Q 1/70; B23Q 11/12; F16C 35/08

(52) U.S. Cl. CPC B23Q 1/703; B23Q 11/12; F16C 35/08

(57) ABSTRACT

A spindle device includes: a rotation shaft; a bearing housing having a cylindrical shape extending in a direction of a center axis of the rotation shaft; a bearing attached to an inner peripheral surface of the bearing housing and rotatably supporting the rotation shaft; and a first elastic member. A first flow path and a second flow path are formed inside the bearing housing, each of the first flow path and the second flow path extending in a direction of a center axis of the bearing housing. A first groove is formed in an outer peripheral surface of the bearing housing, the first groove extending in a peripheral direction of the bearing housing, the first groove being connected to the first flow path and the second flow path. The first elastic member closes an opening of the first groove.

### TECHNICAL FIELD

The present invention relates to a spindle device.

### BACKGROUND ART

PTL 1 (Japanese Patent Laying-Open No. 2014-52081) describes a bearing device. The bearing device described in PTL 1 has a rotation shaft, a housing, a bearing, and a cooling jacket. The housing has a cylindrical shape extending in a direction of a center axis of the rotation shaft. The bearing is attached to an inner peripheral surface of the housing. The bearing rotatably supports the rotation shaft. A cooling oil groove is formed in an outer peripheral surface of the housing. The cooling jacket is attached to the outer peripheral surface of the housing so as to cover the cooling oil groove.

### CITATION LIST

### Patent Literature

PTL 1. Japanese Patent Laying-Open No. 2014-52081

### SUMMARY OF INVENTION

### Technical Problem

In the bearing device described in PTL 1, rotation of the rotation shaft causes generation of heat around the rotation shaft. This generation of heat may cause a change in size of each member around the rotation shaft. In the bearing device described in PTL 1, a cooling oil flows in a flow path defined by the cooling oil groove and the cooling jacket so as to cool the housing, thereby suppressing the above-described change in size. In the bearing device described in PTL 1, however, the flow path is formed by attaching the cooling jacket to the outer peripheral surface of the housing, thus resulting in an increased outer diameter size.

The present invention has been made in view of the above problem of the conventional art. More specifically, the present invention provides a spindle device to suppress an outer diameter size from being increased to form a flow path in which a coolant flows.

### Solution to Problem

A spindle device of the present invention includes: a rotation shaft; a bearing housing having a cylindrical shape extending in a direction of a center axis of the rotation shaft; a bearing attached to an inner peripheral surface of the bearing housing and rotatably supporting the rotation shaft; and a first elastic member. A first flow path and a second flow path are formed inside the bearing housing, each of the first flow path and the second flow path extending in a direction of a center axis of the bearing housing. A first groove is formed in an outer peripheral surface of the bearing housing, the first groove extending in a peripheral direction of the bearing housing, the first groove being connected to the first flow path and the second flow path. The first elastic member closes an opening of the first groove.

The spindle device may further include a first cover attached to the outer peripheral surface of the bearing housing so as to cover the first elastic member.

In the spindle device, a partition may be disposed between a portion of the first groove connected to the first flow path and a portion of the first groove connected to the second flow path.

In the spindle device, the first flow path and the second flow path may be located at different positions in the peripheral direction of the bearing housing.

The spindle device may further include a second elastic member. A second groove is formed in the outer peripheral surface of the bearing housing, the second groove extending in the peripheral direction of the bearing housing, the second groove being connected to the first flow path and the second flow path, the second groove being separated from the first groove in the direction of the center axis of the bearing housing. The second elastic member closes an opening of the second groove.

The spindle device may further include: a motor housing having a cylindrical shape extending in the direction of the center axis of the bearing housing; a motor; and a second cover. The motor may have a stator attached to an inner peripheral surface of the motor housing, and a rotor attached to the rotation shaft so as to face the stator in a radial direction of the motor housing. At least one or more third grooves may be formed in an outer peripheral surface of the motor housing, the at least one or more third grooves extending in a peripheral direction of the motor housing, the at least one or more third grooves being fluidly connected to the second flow path. The second cover may be attached to the outer peripheral surface of the motor cover so as to cover the at least one or more third grooves.

In the spindle device, the at least one or more third grooves may be a plurality of circumferential grooves disposed with a space being interposed between the plurality of circumferential grooves in the direction of the center axis of the rotation shaft. Two adjacent circumferential grooves of the plurality of circumferential grooves in the direction of the center axis of the rotation shaft may be coupled to each other.

In the spindle device, the bearing may be a hydrostatic bearing that supports a load from the rotation shaft in the direction of the center axis of the rotation shaft and a direction orthogonal to the center axis of the rotation shaft.

### Advantageous Effects of Invention

According to the spindle device of the present invention, an outer diameter size of a housing can be suppressed from being increased to form a flow path in which a coolant flows.

### BRIEF DESCRIPTION OF DRAWINGS

FIG. 1 is a first cross sectional view of a spindle device 100.

FIG. 2 is a cross sectional view along II-II in FIG. 1.

FIG. 3 is a cross sectional view along III-II in FIG. 1.

FIG. 4 is an enlarged view at IV in FIG. 1.

FIG. 5 is a second cross sectional view of spindle device 100.

FIG. 6 is a first perspective view of a motor housing 60.

FIG. 7 is a second perspective view of motor housing 60 when viewed in a direction VII in FIG. 6.

FIG. 8 is a first cross sectional view of a spindle device 100 according to a first modification.

FIG. 9 is a second cross sectional view of a spindle device 100 according to a second modification.

FIG. 10 is a perspective view of a spindle device 100 according to a fourth modification.

FIG. 11 is a perspective view of a spindle device 100 according to a fifth modification.

### DESCRIPTION OF EMBODIMENTS

Embodiments of the present invention will be described with reference to figures. In the figures described below, the same or corresponding portions are denoted by the same reference characters and the same explanation will not be described repeatedly.

(Configuration of Spindle Device According to Embodiment)

A configuration of a spindle device (hereinafter referred to as “spindle device 100”) according to an embodiment will be described.

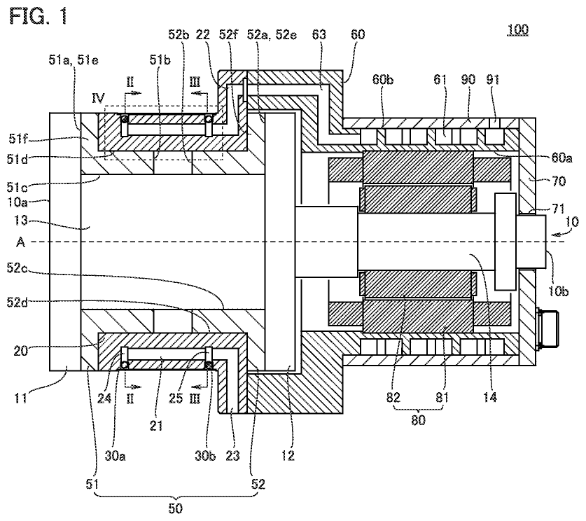

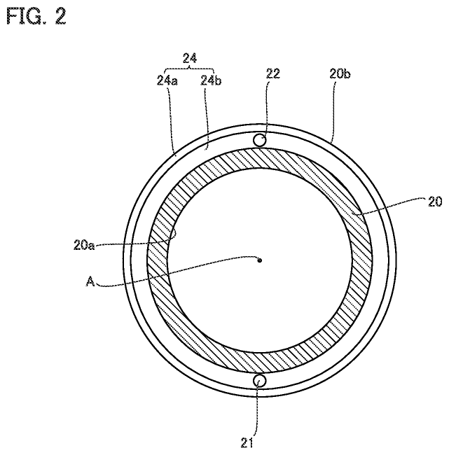

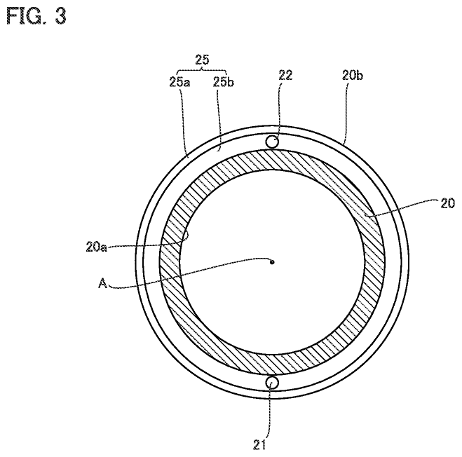

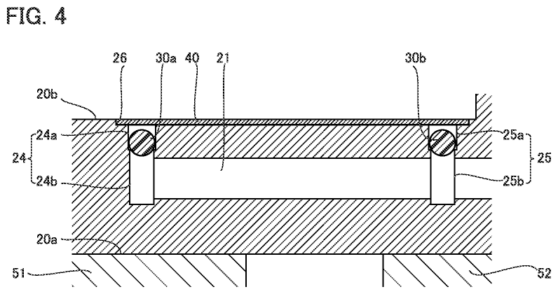

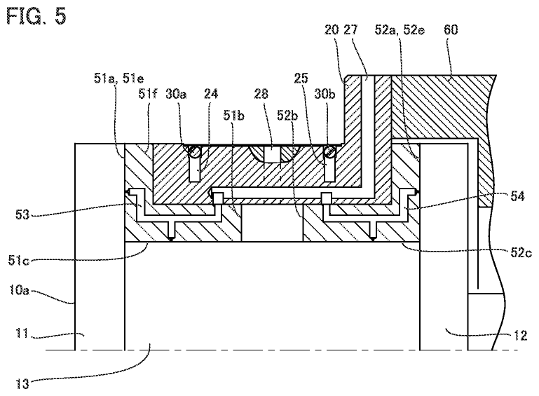

FIG. 1 is a first cross sectional view of spindle device 100. FIG. 2 is a cross sectional view along II-II in FIG. 1. FIG. 3 is a cross sectional view along III-III in FIG. 1. In each of FIGS. 2 and 3, components other than a bearing housing 20 are not illustrated. FIG. 4 is an enlarged view at IV in FIG. 1. FIG. 5 is a second cross sectional view of spindle device 100. As shown in FIGS. 1 to 5, spindle device 100 has a rotation shaft 10, bearing housing 20, an elastic member 30a, an elastic member 30b, a cover 40, a bearing sleeve 50, a motor housing 60, a cover 70, a motor 80, and a cover 90.

The center axis of rotation shaft 10 is defined as a center axis A. Rotation shaft 10 has a first end 10a and a second end 10b in a direction of center axis A. Second end 10b is an end opposite to first end 10a. Rotation shaft 10 has an increased-diameter portion 11 and an increased-diameter portion 12. Increased-diameter portion 11 is located at first end 10a, and increased-diameter portion 12 is located between first end 10a and second end 10b. A portion of rotation shaft 10 located between increased-diameter portion 11 and increased-diameter portion 12 is defined as a first portion 13, and a portion of rotation shaft 10 located on the second end 10b side with respect to increased-diameter portion 12 is defined as a second portion 14.

Each of the outer diameter of rotation shaft 10 in increased-diameter portion 11 and the outer diameter of increased-diameter portion 12 in increased-diameter portion 12 is larger than the outer diameter of rotation shaft 10 in first portion 13. Each of the outer diameter of rotation shaft 10 in increased-diameter portion 11 and the outer diameter of increased-diameter portion 12 in increased-diameter portion 12 is larger than the outer diameter of rotation shaft 10 in second portion 14. Increased-diameter portion 11 and increased-diameter portion 12 protrude from first portion 13 and second portion 14 in a direction orthogonal to center axis A. Each of increased-diameter portion 11, increased-diameter portion 12, first portion 13, and second portion 14 has a circular shape when viewed in a cross section orthogonal to center axis A.

Bearing housing 20 has a cylindrical shape extending in the direction of center axis A. When viewed in the cross section orthogonal to center axis A, bearing housing 20 has an annular shape. Bearing housing 20 has an inner peripheral surface 20a and an outer peripheral surface 20b. A flow path 21, a flow path 22, and a supply port 23 are formed inside bearing housing 20. Each of flow path 21 and flow path 22 extends in the direction of center axis A. Supply port 23 is connected to flow path 21 at one end and is connected to outside of bearing housing 20 at the other end.

In the peripheral direction of bearing housing 20, flow path 21 and flow path 22 are located at different positions. For example, flow path 22 is located at a position point-symmetric thereto with respect to center axis A when viewed in the cross section orthogonal to center axis A.

A groove 24 is formed in outer peripheral surface 20b. Groove 24 extends in the peripheral direction of bearing housing 20. Groove 24 is connected to flow path 21 and flow path 22. Groove 24 is, for example, a circumferential groove. However, groove 24 is not limited to the circumferential groove. In other words, groove 24 may not extend around a whole of outer peripheral surface 20b along the peripheral direction of bearing housing 20. Groove 24 has a first portion 24a and a second portion 24b. First portion 24a is a portion of groove 24 on the outer peripheral surface 20b side. Second portion 24b is a portion of groove 24 on the inner side with respect to first portion 24a in the radial direction of bearing housing 20. The width of first portion 24a in the direction of center axis A is larger than the width of second portion 24b in the direction of center axis A. The width of second portion 24b in the direction of center axis A is smaller than the outer diameter of elastic member 30a. Groove 24 is connected to flow path 21 and flow path 22 in second portion 24b.

A groove 25 is formed in outer peripheral surface 20b. Groove 25 extends in the peripheral direction of bearing housing 20. Groove 25 is connected to flow path 21 and flow path 22. Groove 25 is, for example, a circumferential groove. However, groove 25 is not limited to the circumferential groove. In other words, groove 25 may not extend around a whole of outer peripheral surface 20b along the peripheral direction of bearing housing 20. Groove 25 has a first portion 25a and a second portion 25b. First portion 25a is a portion of groove 25 on the outer peripheral surface 20b side. Second portion 25b is a portion of groove 25 on the inner side with respect to first portion 25a in the radial direction of bearing housing 20. The width of first portion 25a in the direction of center axis A is larger than the width of second portion 25b in the direction of center axis A. The width of second portion 25b in the direction of center axis A is smaller than the outer diameter of elastic member 30b Groove 25 is connected to flow path 21 and flow path 22 in second portion 25b Groove 24 and groove 25 are separated from each other in the direction of center axis A. In the direction of center axis A, groove 24 is located close to first end 10a with respect to groove 25.

A groove 26 is formed in outer peripheral surface 20b. Groove 26 extends in the peripheral direction of bearing housing 20. Groove 24 and groove 25 are formed in the bottom surface of groove 26. That is, one end of groove 26 in the direction of center axis A is located close to first end 10a with respect to groove 24, and the other end of groove 26 in the direction of center axis A is located close to second end 10b with respect to groove 25.

Elastic member 30a closes the opening of groove 24. Elastic member 30a is disposed in groove 24. More specifically, elastic member 30a is disposed in first portion 24a. Elastic member 30b closes the opening of groove 25. Elastic member 30b is disposed in groove 25. More specifically, elastic member 30b is disposed in first portion 25a. Each of elastic member 30a and elastic member 30b is, for example, an annular member. Each of elastic member 30a and elastic member 30b is, for example, an O-ring.

A coolant supplied from supply port 23 is supplied to flow path 21. A part of the coolant having flowed in flow path 21 and having reached groove 25 flows to flow path 22 through groove 25. The remainder of the coolant having flowed in flow path 21 and having reached groove 25 flows in flow path 22 directly. The coolant having flowed in flow path 22 and having reached groove 24 flows in flow path 22 through groove 24, and is merged with the coolant having flowed in groove 25 and having reached flow path 22. It should be noted that since the opening of groove 24 is closed by elastic member 30a and the opening of groove 25 is closed by elastic member 30b, the coolant is suppressed from being leaked to the outside of bearing housing 20.

Cover 40 is attached to outer peripheral surface 20b. More specifically, cover 40 is disposed in groove 26. The thickness of cover 40 is preferably equal to or less than the depth of groove 26. Since cover 40 is attached to outer peripheral surface 20b, elastic member 30a and elastic member 30b are suppressed from being detached from groove 24 and groove 25 respectively due to pressure of the coolant.

Bearing sleeve 50 has a first member 51 and a second member 52. Each of first member 51 and second member 52 has a cylindrical shape extending in the direction of center axis A. Each of first member 51 and second member 52 has an annular shape when viewed in the cross section orthogonal to center axis A. First member 51 has a first end 51a and a second end 51b in the direction of center axis A. Second end 51b is located opposite to first end 51a First end 51a is located on the first end 10a side, and second end 51b is located on the second end 10b side. Second member 52 has a first end 52a and a second end 52b in the direction of center axis A. Second end 52b is located opposite to first end 52a. First end 52a is located on the second end 10b side, and second end 52b is located on the first end 10a side.

First member 51 and second member 52 are arranged side by side in the direction of center axis A such that second end 51b and second end 52b face each other with a space being interposed therebetween. First member 51 has an inner peripheral surface 51c, an outer peripheral surface 51d, and an end surface 51e. End surface 51e is an end surface on the first end 51a side of first member 51. End surface 51e faces increased-diameter portion 11 with a small space being interposed therebetween. Second member 52 has an inner peripheral surface 52c, an outer peripheral surface 52d, and an end surface 52e. End surface 52e is an end surface on the first end 52a side of second member 52. End surface 52e faces increased-diameter portion 12 with a small space being interposed therebetween.

First member 51 has an increased-diameter portion 51f. First member 51 protrudes in increased-diameter portion 51f in the direction orthogonal to center axis A. Preferably, the outer diameter of first member 51 in increased-diameter portion 51f is equal to the outer diameter of rotation shaft 10 in increased-diameter portion 11. Second member 52 has an increased-diameter portion 52f. Second member 52 protrudes in increased-diameter portion 52f in the direction orthogonal to center axis A. Preferably, the outer diameter of second member 52 in increased-diameter portion 52f is equal to the outer diameter of rotation shaft 10 in increased-diameter portion 11.

Bearing sleeve 50 is attached to inner peripheral surface 20a. More specifically, outer peripheral surface 51d and outer peripheral surface 52d are in contact with inner peripheral surface 20a. Further, increased-diameter portion 51f and increased-diameter portion 52f sandwich bearing housing 20 in the direction of center axis A. Each of inner peripheral surface 51c and inner peripheral surface 52c face the outer peripheral surface of rotation shaft 10 (first portion 13) with a small space being interposed therebetween.

A flow path 53 is formed inside first member 51, and a flow path 54 is formed inside second member 52. A flow path 27 and a flow path 28 are formed inside bearing housing 20. Flow path 53 and flow path 54 are connected to flow path 27. Flow path 53 is opened at inner peripheral surface 51c and end surface 51e Flow path 54 is opened at inner peripheral surface 52c and end surface 52e. Flow path 27 is connected to the outside of bearing housing 20 on the side opposite to flow path 53 and flow path 54.

Air is supplied to flow path 53 and flow path 54 through flow path 27. The air supplied to flow path 53 is jetted from inner peripheral surface 51c and end surface 51e, and the air supplied to flow path 54 is jetted from inner peripheral surface 52c and end surface 52e. With the pressure of the air, the load applied to rotation shaft 10 in the direction of center axis A and the direction orthogonal to center axis A while rotating rotation shaft 10 about center axis A is supported. That is, in spindle device 100, rotation shaft 10 is supported to be rotatable about center axis A by the hydrostatic bearing. It should be noted that the air jetted from each of inner peripheral surface 51c, end surface 51e, inner peripheral surface 52c, and end surface 52e is discharged to the outside of bearing housing 20 through a space between first member 51 and second member 52 and flow path 28.

Motor housing 60 has a cylindrical shape extending in the direction of center axis A. Motor housing 60 has an annular shape when viewed in the cross section orthogonal to center axis A. One end of motor housing 60 in the direction of center axis A is closed by cover 70. A through hole 71 is formed in cover 70. Through hole 71 extends through cover 70 along the thickness direction (direction of center axis A). The other end of motor housing 60 in the direction of center axis A is attached to bearing housing 20. Increased-diameter portion 12 and second portion 14 are located inside motor housing 60. Second end 10b protrudes from through hole 71.

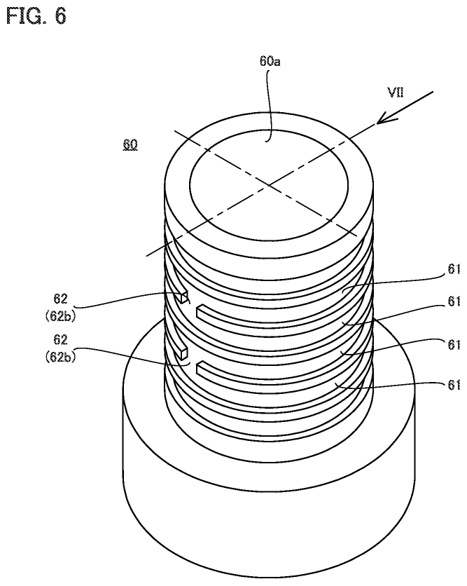

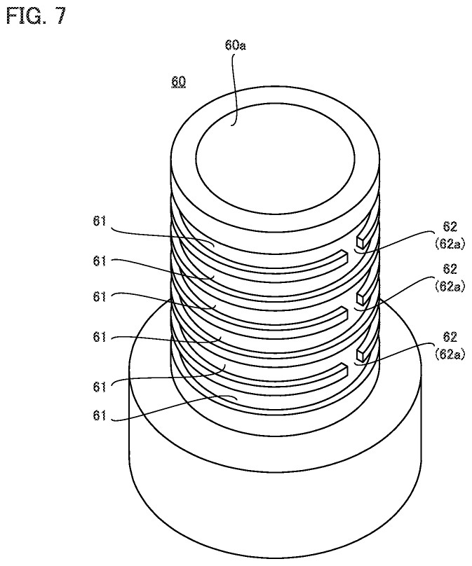

Motor housing 60 has an inner peripheral surface 60a and an outer peripheral surface 60b. FIG. 6 is a first perspective view of motor housing 60. FIG. 7 is a second perspective view of motor housing 60 when viewed in a direction VII in FIG. 6. As shown in FIGS. 6 and 7, a plurality of grooves 61 are formed in outer peripheral surface 60b. Each of grooves 61 is a circumferential groove formed along the peripheral direction of motor housing 60. Two grooves 61 adjacent to each other in the direction of center axis A are disposed with a space being interposed therebetween.

A notch 62 is formed in outer peripheral surface 60b between two adjacent grooves 61. Two adjacent grooves 61 are connected to each other by notch 62. Notch 62 is formed, for example, along the direction of center axis A.

Notches 62 disposed in odd-numbered orders counted from one end side of motor housing 60 in the direction of center axis A are defined as notches 62a, and notches 62 disposed in even-numbered orders counted from one end side of motor housing 60 in the direction of center axis A are defined as notches 62b. Notches 62a are arranged to form a row along the direction of center axis A, and notches 62b are arranged to form a row along the direction of center axis A. The row of notches 62a is located at a position different from the position of the row of notches 62b in the peripheral direction of motor housing 60. More specifically, the row of notches 62a is located at a position point-symmetric to the row of notches 62b with respect to center axis A.

A flow path 63 is formed inside motor housing 60. Flow path 63 extends in the direction of center axis A. Flow path 63 is connected to groove 61 at one end and is connected to flow path 22 at the other end. Thus, groove 61 is fluidly connected to flow path 22

Motor 80 has a stator 81 and a rotor 82. Stator 81 is attached to inner peripheral surface 60a. Stator 81 is constituted of, for example, a plurality of coil bodies disposed along the peripheral direction of motor housing 60. Rotor 82 is attached to rotation shaft 10 (second portion 14) so as to face stator 81 in the radial direction of motor housing 60. Rotor 82 is, for example, a permanent magnet. Motor 80 rotates rotor 82 by sequentially exciting the plurality of coil bodies of stator 81 along the peripheral direction of motor housing 60 in accordance with a signal from a motor driver circuit (not shown). With this rotation, rotation shaft 10 to which rotor 82 is attached is rotated about center axis A. Motor 80 is, for example, an induction motor or a PM (Permanent Magnet) motor. When motor 80 is an induction motor, rotor 82 is an electromagnetic steel sheet, and when motor 80 is a PM motor, rotor 82 is a permanent magnet.

Cover 90 is attached to outer peripheral surface 60b so as to cover groove 61. The inner peripheral surface of cover 90 and groove 61 define a flow path. A discharge port 91 is formed in cover 90. Discharge port 91 extends through cover 90 so as to communicate with the flow path defined by the inner peripheral surface of cover 90 and groove 61. The coolant having flowed in flow path 22 is supplied via flow path 63 to the flow path defined by the inner peripheral surface of cover 90 and groove 61. The coolant having flowed in the flow path is discharged from discharge port 91. Thus, motor 80 is cooled.

(Effects of Spindle Device According to Embodiment)

Effects of spindle device 100 will be described.

In spindle device 100, the flow path in which the coolant for cooling bearing sleeve 50 flows is defined by flow path 21, flow path 22, groove 24, groove 25, elastic member 30a, and elastic member 30b. Flow path 21 and flow path 22 are formed inside bearing housing 20. Groove 24 and groove 25 are formed in outer peripheral surface 20b. Elastic member 30a and elastic member 30b are disposed in groove 24 and groove 25 respectively. Therefore, in spindle device 100, the outer diameter size is not increased by forming the flow path in which the coolant for cooling bearing sleeve 50 flows.

When the outer diameter size of the spindle device is increased to form the flow path in which the coolant for cooling the bearing sleeve flows, it is necessary to maintain the outer diameter size of the spindle device by reducing the outer diameter size of the bearing housing. In this case, as the outer diameter size of the bearing housing is reduced, the outer diameter of the bearing sleeve is also reduced, thereby decreasing the axial load (load in the direction of the center axis of the rotation shaft) that can be supported by the bearing sleeve.

However, in spindle device 100, the outer diameter size is not increased to form the flow path in which the coolant for cooling bearing sleeve 50 flows, so that it is not necessary to reduce the outer diameter size of bearing housing 20. As a result, according to spindle device 100, the axial load that can be supported by bearing sleeve 50 can be maintained.

In spindle device 100, since cover 40 is attached to outer peripheral surface 20b so as to cover elastic member 30a and elastic member 30b, elastic member 30a and elastic member 30b are suppressed from being detached due to pressure of the coolant. It should be noted that since cover 40 is disposed in groove 26 and the thickness of cover 40 is equal to or less than the depth of groove 26, the outer size of spindle device 100 is not increased by attaching cover 40 to outer peripheral surface 20b.

When groove 24 has first portion 24a and second portion 24b (groove 25 has first portion 25a and second portion 25b), elastic member 30a (elastic member 30b) is stopped at a step between first portion 24a and second portion 24b (step between first portion 25a and second portion 25b), thereby stabilizing the installation position of elastic member 30a (elastic member 30b).

In spindle device 100, flow path 21 and flow path 22 are located at positions point-symmetric to each other with respect to center axis A when viewed in the cross section orthogonal to center axis A. Therefore, the flow of the coolant flowing in flow path 21 can be branched in two directions in groove 24 and groove 25.

In spindle device 100, the plurality of grooves 61 are formed in outer peripheral surface 60b, the plurality of grooves 61 being coupled together by notches 62, the plurality of grooves 61 being fluidly connected to flow path 22. In spindle device 100, cover 90 is attached to outer peripheral surface 60b. Therefore, according to spindle device 100, motor 80 can be further cooled by the coolant that has cooled bearing sleeve 50.

When groove 61 is a circumferential groove extending in the peripheral direction of motor housing 60, processing to form groove 61 can be readily performed. When the row of notches 62a and the row of notches 62b are located at positions point-symmetric to each other with respect to center axis A, the coolant can be uniformly supplied to outer peripheral surface 60b, thereby improving the cooling efficiency of motor 80.

(First Modification)

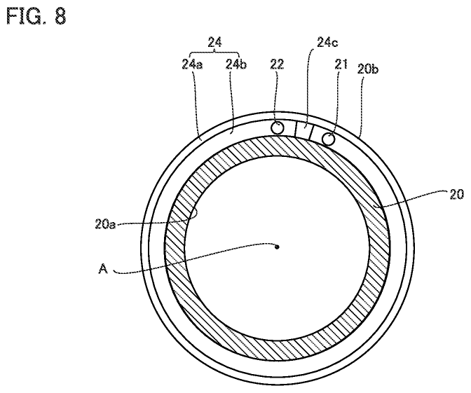

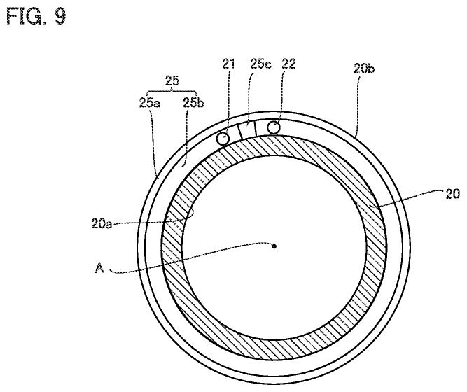

FIG. 8 is a first cross sectional view of a spindle device 100 according to a first modification. FIG. 9 is a second cross sectional view of a spindle device 100 according to a second modification. FIG. 8 shows a cross section at a position corresponding to II-II in FIG. 1. FIG. 9 shows a cross section at a position corresponding to III-III in FIG. 1. As shown in FIGS. 8 and 9, groove 24 and groove 25 are provided with a partition portion 24c and a partition portion 25c, respectively.

In spindle device 100 according to the first modification, flow path 21 and flow path 22 are disposed to form an angle of 90° or less when viewed in the cross section orthogonal to center axis A by a straight line connecting center axis A and the center of flow path 21 and a straight line connecting center axis A and the center of flow path 22. This angle is preferably 45° or less.

Partition portion 24c is disposed between flow path 21 and flow path 22 in the peripheral direction of bearing housing 20. Partition portion 24c protrudes from the bottom surface of groove 24 along the radial direction of bearing housing 20. Partition portion 25c is disposed between flow path 21 and flow path 22 in the peripheral direction of bearing housing 20. Partition portion 25c protrudes from the bottom surface of groove 25 along the radial direction of bearing housing 20. Thus, the flow of the coolant flowing in each of groove 24 and groove 25 becomes a flow in one direction. It should be noted that partition portion 24c and partition portion 25c may be portions of bearing housing 20 or may be members different from bearing housing 20.

(Second Modification)

In spindle device 100 according to the second modification, groove 61 may be a helical groove, rather than the circumferential groove. It should be noted that in spindle device 100 according to the second modification, notch 62 is not formed in outer peripheral surface 60b.

(Third Modification)

In a spindle device 100 according to a third modification, instead of bearing sleeve 50, one or a plurality of rolling bearings may be used to support rotation shaft 10 to be rotatable about center axis A. It should be noted that in spindle device 100 according to the third embodiment, flow path 27 is not formed inside bearing housing 20.

(Fourth Modification and Fifth Modification)

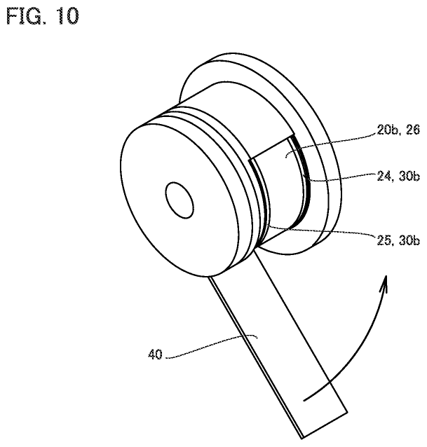

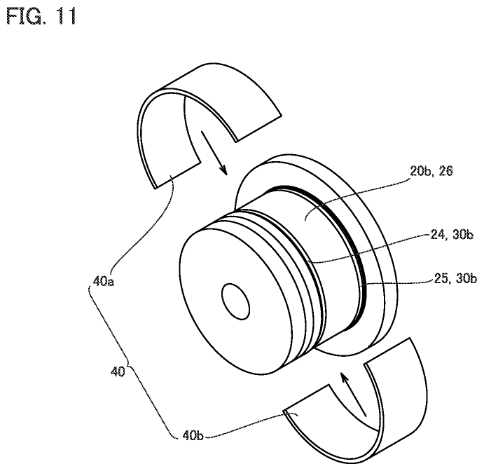

FIG. 10 is a perspective view of a spindle device 100 according to a fourth modification. As shown in FIG. 10, cover 40 is a plate-shaped member and may be wound around outer peripheral surface 20b (groove 26). In this case, cover 40 can be readily attached. FIG. 11 is a perspective view of a spindle device 100 according to a fifth modification. As shown in FIG. 11, cover 40 may be divided into a plurality of portions in the peripheral direction. For example, cover 40 may be divided in the peripheral direction into two, i.e., a divided cover 40a and a divided cover 40b. However, the number of divisions of cover 40 is not limited to two. In this case, cover 40 can be readily attached.

Although the embodiments of the present invention have been illustrated, the embodiments described above can be modified in various manners. Further, the scope of the present invention is not limited to the above-described embodiments. The scope of the present invention is defined by the terms of the claims, and is intended to include any modifications within the scope and meaning equivalent to the terms of the claims.

### INDUSTRIAL APPLICABILITY

The above-described embodiment is particularly advantageously applied to an air spindle device for a processing machine.

### REFERENCE SIGNS LIST

100: spindle device; 10: rotation shaft; 10a: first end; 10b: second end; 11; increased-diameter portion; 12: increased-diameter portion; 13: first portion; 14: second portion; 20: bearing housing 20a: inner peripheral surface; 20b: outer peripheral surface; 21: flow path; 22: flow path; 23: supply port; 24: groove; 24a: first portion; 24b: second portion, 24c, partition portion; 25: groove; 25a: first portion, 25b: second portion; 25c: partition portion; 26: groove; 27: flow path, 28: flow path; 30a: elastic member; 30b: elastic member; 40: cover; 40a: divided cover; 40b: divided cover; 50: bearing sleeve; 51: first member; 51a: first end, 51b: second end; 51c: inner peripheral surface; 51d: outer peripheral surface; 51e: end surface; 51f: increased-diameter portion; 52: second member; 52a: first end; 52b: second end; 52c: inner peripheral surface; 52d: outer peripheral surface; 52e: end surface; 52f: increased-diameter portion; 53: flow path; 54: flow path; 60: motor housing; 60a: inner peripheral surface; 60b: outer peripheral surface; 61: groove; 62: notch; 62a: notch; 62 notch; 631 flow path; 70: cover; 71: through hole; 80: motor; 81: stator; 82: rotor, 90: cover; 91: discharge port.

1. A spindle device comprising:
a rotation shaft;
a bearing housing having a cylindrical shape extending in a direction of a center axis of the rotation shaft;
a bearing attached to an inner peripheral surface of the bearing housing and rotatably supporting the rotation shaft; and
a first elastic member, wherein
a first flow path and a second flow path are formed inside the bearing housing, each of the first flow path and the second flow path extending in a direction of a center axis of the bearing housing,
a first groove is formed in an outer peripheral surface of the bearing housing, the first groove extending in a peripheral direction of the bearing housing, the first groove being connected to the first flow path and the second flow path, and
the first elastic member closes an opening of the first groove.

2. The spindle device according to claim 1, further comprising a first cover attached to the outer peripheral surface of the bearing housing so as to cover the first elastic member.

3. The spindle device according to claim 1, wherein a partition is disposed between a portion of the first groove connected to the first flow path and a portion of the first groove connected to the second flow path.

4. The spindle device according to claim 1, wherein the first flow path and the second flow path are located at different positions in the peripheral direction of the bearing housing.

5. The spindle device according to claim 1, further comprising a second elastic member, wherein
a second groove is formed in the outer peripheral surface of the bearing housing, the second groove extending in the peripheral direction of the bearing housing, the second groove being connected to the first flow path and the second flow path, the second groove being separated from the first groove in the direction of the center axis of the bearing housing, and
the second elastic member closes an opening of the second groove.

6. The spindle device according to claim 1, further comprising:
a motor housing having a cylindrical shape extending in the direction of the center axis of the bearing housing;
a motor; and
a second cover, wherein
the motor has a stator attached to an inner peripheral surface of the motor housing, and a rotor attached to the rotation shaft so as to face the stator in a radial direction of the motor housing,
at least one or more third grooves are formed in an outer peripheral surface of the motor housing, the at least one or more third grooves extending in a peripheral direction of the motor housing, the at least one or more third grooves being fluidly connected to the second flow path, and
the second cover is attached to the outer peripheral surface of the motor housing so as to cover the at least one or more third grooves.

7. The spindle device according to claim 6, wherein
the at least one or more third grooves are a plurality of circumferential grooves disposed with a space being interposed between the plurality of circumferential grooves in the direction of the center axis of the rotation shaft, and
two adjacent circumferential grooves of the plurality of circumferential grooves in the direction of the center axis of the rotation shaft are coupled to each other.

8. The spindle device according to claim 1, wherein the bearing is a hydrostatic bearing that supports a load from the rotation shaft in the direction of the center axis of the rotation shaft and a direction orthogonal to the center axis of the rotation shaft.
